(19) United States
(12) Patent Application Publication
(10) Pub. No.: US 2006/0026104 A1
(43) Pub. Date: Feb. 2, 2006

(54) SYSTEM AND METHOD FOR MAKING COPYRIGHTABLE MATERIAL AVAILABLE

(76) Inventor: Toshiyasu Abe, Bellevue, WA (US)

Correspondence Address: BLACK LOWE & GRAHAM, PLLC, 701 FIFTH AVENUE, SUITE 4800, SEATTLE, WA, 98104, US

(21) Appl. No.: 10/710,705

(22) Filed: Jul. 29, 2004

(51) Int. Cl. G06Q 99/00

(52) U.S. Cl. 705/57

(57) ABSTRACT

A method and system that allows people to make authorized copies of works while compensating the authors/artists associated with copied works. The system includes an authorizing authority that authorizes a purchaser of a recording medium to make copies of certain works onto the purchased recording medium. The authorizing authority distributes a portion of the sale of the recording medium to registered entities associated with the certain works.

### FIELD OF THE INVENTION

This invention relates to methods and systems for the management of works of authorship and, more particularly, to such methods and systems to facilitate artist and author compensation for copies of their works.

### BACKGROUND OF THE INVENTION

Many people have and continue to download or make copies of copyrighted works, especially music, without permission from the copyright holders (i.e., artists, authors, or producers). These people, many of them teens and preteens, often do so in violation of copyright law.

Because of Napster-like technology, as well as other readily available technologies, it is very easy for the average person to make copies of music, journal articles, photographs, and other works. For example, many peer-to-peer file sharing services allow users to exchange videos, graphics, software and electronic books. Many people have a level of cynicism when they can so easily make copies of works and are at the same time told that that type of copying is illegal. All digitized media is up for grabs and other industries—including motion pictures and book publishers—are scrambling to find ways to protect their assets. Presently there are many groups that are trying to use technology to stop unauthorized copying of works. Yet, copies of present works can be easily made and are being made.

For the most part, the music industry hasn't aimed its legal guns at individuals who download music, because it is too difficult to catch everyone and the damages caused by one person making one unauthorized copy is hardly worth the effort. More recently, some individual enforcement has taken place, with individual lawsuits being filed in order to make examples of some individuals and, hopefully, dissuade others from pirating music and other works.

While the copyright law makes some “fair use” exceptions for uses such as educational use of copyrighted material, fair use does not extend to many typical uses. Though piracy receives much media attention, there are many who make copies illegally simply because there is no convenient means for proper payment. Many, if not most, people would pay for the copies they make if there were only a system to do so.

Therefore, there exists a need to give people the opportunity to make the correct moral and legal choice when it comes to making copies of copyrightable works.

### SUMMARY OF THE INVENTION

The present invention provides a method and system that allows people to make authorized copies of works while compensating the authors/artists associated with copied works.

A preferred embodiment of the system includes an authorizing authority that authorizes a purchaser of a recording medium to make copies of certain works onto the purchased recording medium. The authorizing authority distributes a portion of the sale of the recording medium to registered entities associated with the certain works.

The recording medium includes, for example, computer disks (hard drive, cds, etc.), digital video disks, computer floppy disks, memory cards, or paper.

The recording medium may include a written authorization or a unique identifier.

In accordance with further preferred aspects of the invention, the identifier is stored electronically on the recording medium.

In accordance with other preferred aspects of the invention, the authorizing authority includes a data entry device that receives the identifier, a memory that includes approved access code or identifier information, and a processor in communication with the data entry device and the memory. The processor determines if the identifier is one of the approved identifiers/access codes based on the approved identifier/access code information, and instructs the purchaser having an approved identifier/access code that they are authorized to make copies of works onto the blank medium.

In accordance with still further preferred aspects of the invention, a database stores works of the registered entities. The processor allows purchasers having an approved identifier/access code to copy works stored on the database to their blank medium.

In accordance with yet other preferred aspects of the invention, the processor is in communication with a network and receives an identifier associated with a purchased recording medium from a purchaser using a computer device coupled to the network, receives purchaser information, determines if the identifier is valid, and registers the purchaser associated with the received purchaser information for an award if the received identifier is determined valid.

In accordance with still another preferred aspect of the invention, the registered entities include at least one of an artist, an author, or a royalty organization.

### BRIEF DESCRIPTION OF THE DRAWINGS

The preferred and alternative embodiments of the present invention are described in detail below with reference to the following drawings.

FIG. 1 illustrates an exemplary blocked diagram of components of an embodiment of the present invention;

FIG. 2 illustrates a process performed by the system shown in FIG. 1;

FIGS. 3 and 4 illustrate network access pages for allowing a user to interact with a component of the system shown in FIG. 1; and

FIG. 5 illustrates a front view of a packaging example for the present invention.

### DETAILED DESCRIPTION OF THE PREFERRED EMBODIMENT

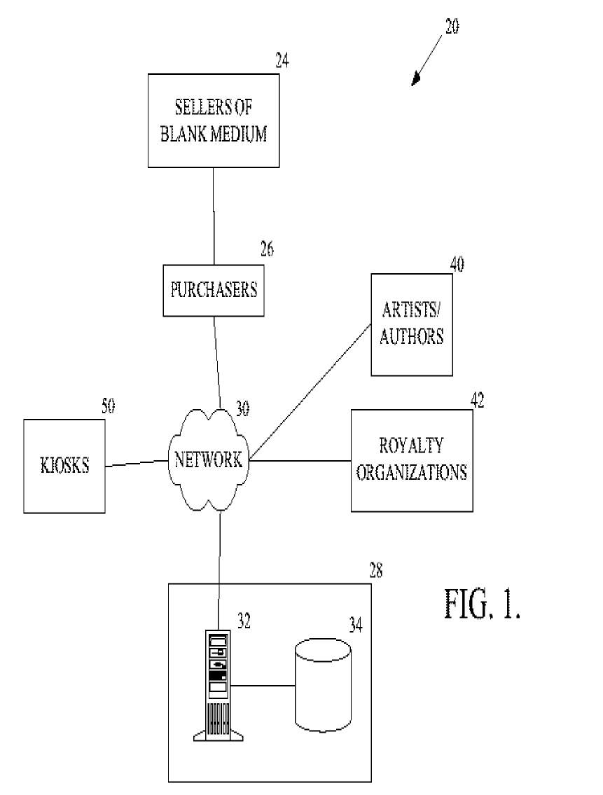

FIG. 1 illustrates a system 20 that includes processes for motivating consumers to adhere to copyright laws. A consumer or purchasers 26 purchase blank recording medium from sellers 24. Examples of blank recording medium include computer disks (CDs), digital video disks (DVDs), any form of paper (e.g., blank sheet music or just blank paper), computer floppy disks, removable memory cards, film, computer hard drives, or any other type of medium that allows recordation of written or electronic data.

The blank recording medium includes or is associated with an authorization that allows purchasers 26 to legally record works produced by artists/authors 40 or works associated with royalty organizations 42 that subscribe, are associated with, or supported by a controlling authority 28. Examples of works include music, books, software, or any other produced work that may be protectable under copyright law. Artists/authors 40 include any of musicians, songwriters, book or software authors, or any other person who can retain the benefit of copyright protection. Examples of royalty organizations 42 are American Society of Composers, Authors, & Publishers (ASCAP) and Broadcast Music Incorporated (BMI). It should be understood that artists/authors 40 and royalty organizations 42 may be readily replaced with any other person or entity seeking to collect a fee for use of a work.

In one embodiment, the controlling authority 28 includes a server 32 coupled to a database 34 that is connected up to a public or private data network 30, such as the Internet. Purchasers 26 or anyone having access to the network 30 may access web pages generated by the server 32 to allow for interaction with the service provided by the controlling authority 28. The controlling authority 28 registers artists/authors 40 or royalty organizations 42 to the service that they provide. Registered artist/author 40 or royalty organizations 42 may receive monetary or other benefits related to a portion of the sale of the blank mediums. In return for a portion of the revenue of the blank medium, the artist/author 40 or royalty organizations 42 give authority for purchasers 26 to copy some or all of their works onto the blank medium that have been purchased by the purchaser 26. If a royalty organization 42 receives the monetary or other benefits, it may distribute some of the money or benefits to artists/authors that they have relationships with.

The controlling authority 28 allows artists/authors 40 and royalty organizations 42 to register for their service by various methods. In one embodiment, the controlling authority 28 allows artists/authors 40 and royalty organizations 42 to register using a secure network-based application program. The artists/authors 40 and royalty organizations 42 submit information during the registration process that allows the controlling authority 28 to manually or automatically send monetary or other benefits (royalties) associated with the sale of the blank medium. Also, the artists/authors 40 and royalty organizations 42 submit authorization to allow the purchasers 26 to make copies of their works onto the blank medium.

In one embodiment, the system 20 includes processor-based kiosks 50 that include a user interface, a processor, memory, and data write device. The kiosks 50 may be coupled to the server 32 via the network 30. The kiosks 50 store works by artists/authors 40 in the memory. A user can download works to a purchased blank medium inserted in the data write device.

The kiosks 50 may also include blank medium. A user selects work(s) stored in the memory of the kiosks 50 or stored at the database 34. Upon payment received by the kiosks 50, the kiosks' processor stores the selected work(s) on one of the included blank medium and presents the medium to the user. The kiosks 50 include a device for receiving money and/or a device for processing credit or bank cards or any other type of cash value electronic card. Although “kiosks” are shown in FIG. 1, the kiosks may alternatively take the form of home or other computers that are similarly equipped and in communication with the network 30. In such an embodiment, the blank medium are purchased separately, then inserted into the computer CD-drive or printer to enable making a copy.

In other embodiments, the blank medium may include special use paper for sale. Also, a dedicated copier allows copying and charges a higher price for the authorized copying service.

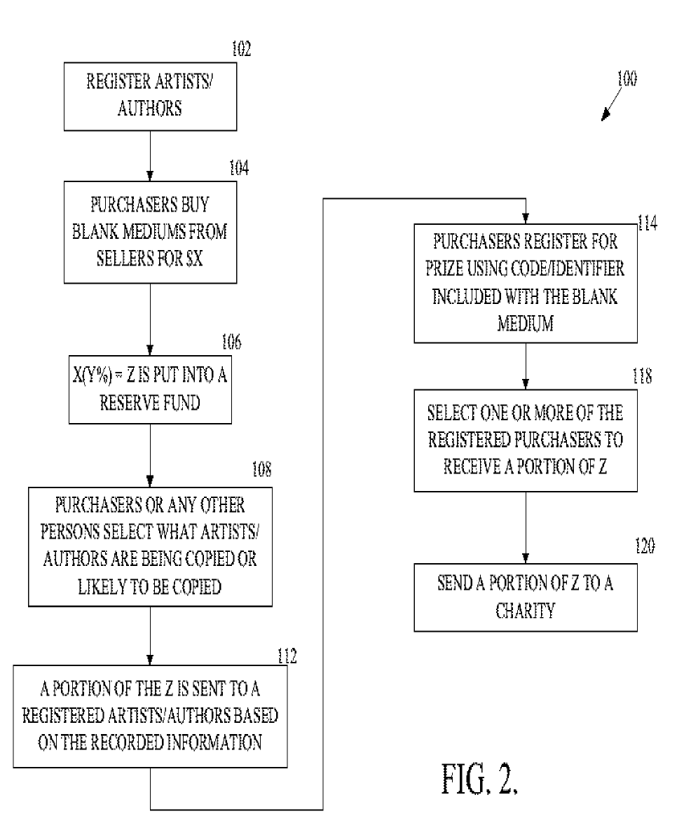

FIG. 2 illustrates an exemplary process 100 performed by components of the system 20 shown in FIG. 1. At a block 102, the controlling authority 28 registers artists/authors 40 or royalty organizations 42 for the service related to the sale of authorized blank medium. Information about subscribing artists/authors 40 or royalty organizations 42 are recorded in the database 34 (FIG. 1). At a block 104, purchasers 26 buy blank mediums that have been authorized or sanctioned by the controlling authority 28. The purchasers 26 buy the blank medium for X dollars from sellers 24. The sellers 24 may be any of a retailer, wholesaler, or the controlling authority 28. At a block 106, the controlling authority 28 sets aside a percentage of the dollar amount (% of X=Z dollars) for the purchased blank mediums.

At a block 108, the purchasers 26 or any other persons select artists/authors that are copied or most likely to be copied. This selected information is recorded by the controlling authority 28 in the database 34. At a block 112, the controlling authority 28 sends the Z dollars (or a portion of the Z dollars) to one or more of the registered artists/authors 40 or royalty organizations 42 based on the recorded information and/or predefined distribution information. In another embodiment, the controlling authority 28 directs the seller 24 where to send the Z dollars.

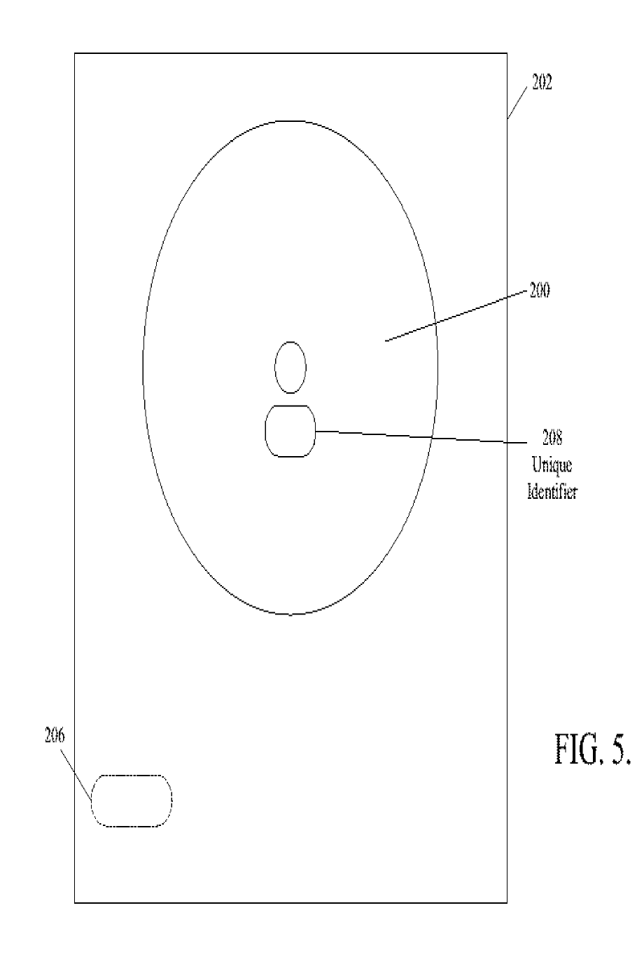

At a block 114, the purchasers 26 register for a prize using an identifier that is included with the purchased blank medium. The identifier may be included on a document or sticker included in the packaging of the blank medium, printed on the blank medium, or the identifier may be in electronic form stored on the blank medium (see FIG. 5). At a block 118, the controlling authority 28 selects one or more registered purchasers 26 to receive a portion of the Z dollars. At a block 120, the controlling authority 28 sends a portion of the dollar amount Z to a charity, a nonprofit organization, or some special project or task. The charity or other is selected by purchasers 26 or users that access web pages generated by the controlling authority 28, by the registered artists/authors 40 or royalty organizations 42, or by the controlling authority 28.

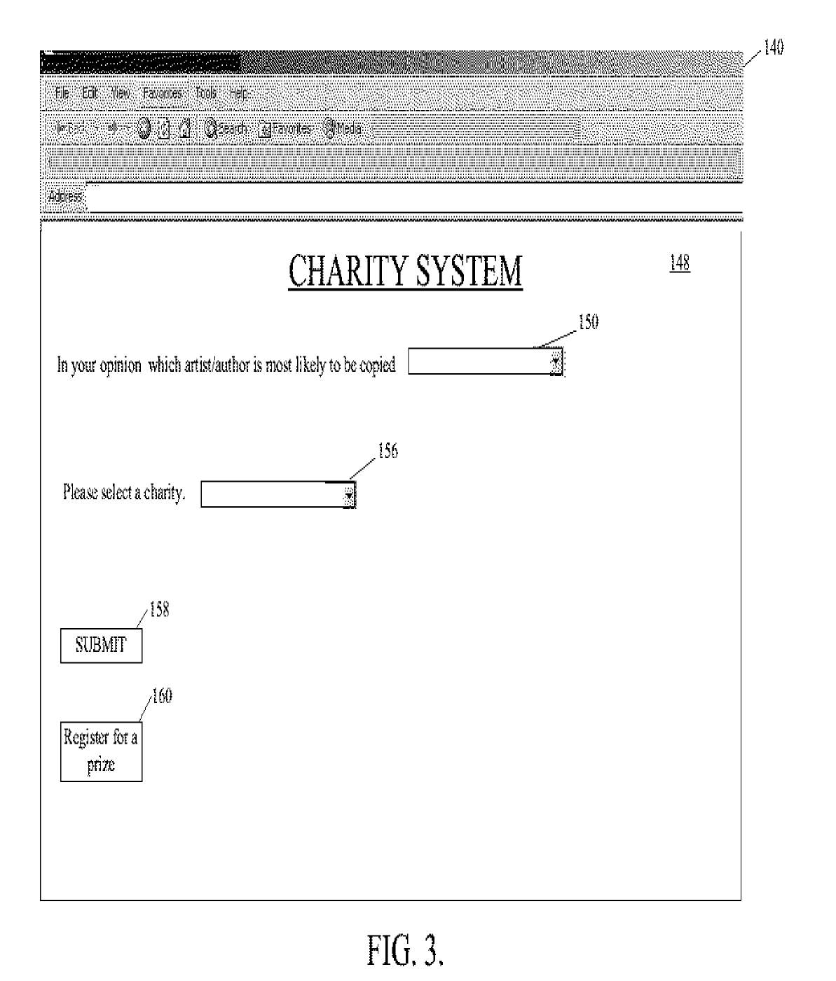

FIG. 3 illustrates a user interface window (web page) 140 generated by the server 32 and accessible over the network 30 by purchasers 26 or any one desiring to interact with the service provided by the controlling authority 28. Users or purchasers 26 interact with the windows generated by the server 32 with a user interface device, such as a display, mouse, keyboard, touch screen, personal data assistant (PDA), or any other device that allows display button selection/activation or entry/selection of text (alphanumeric characters).

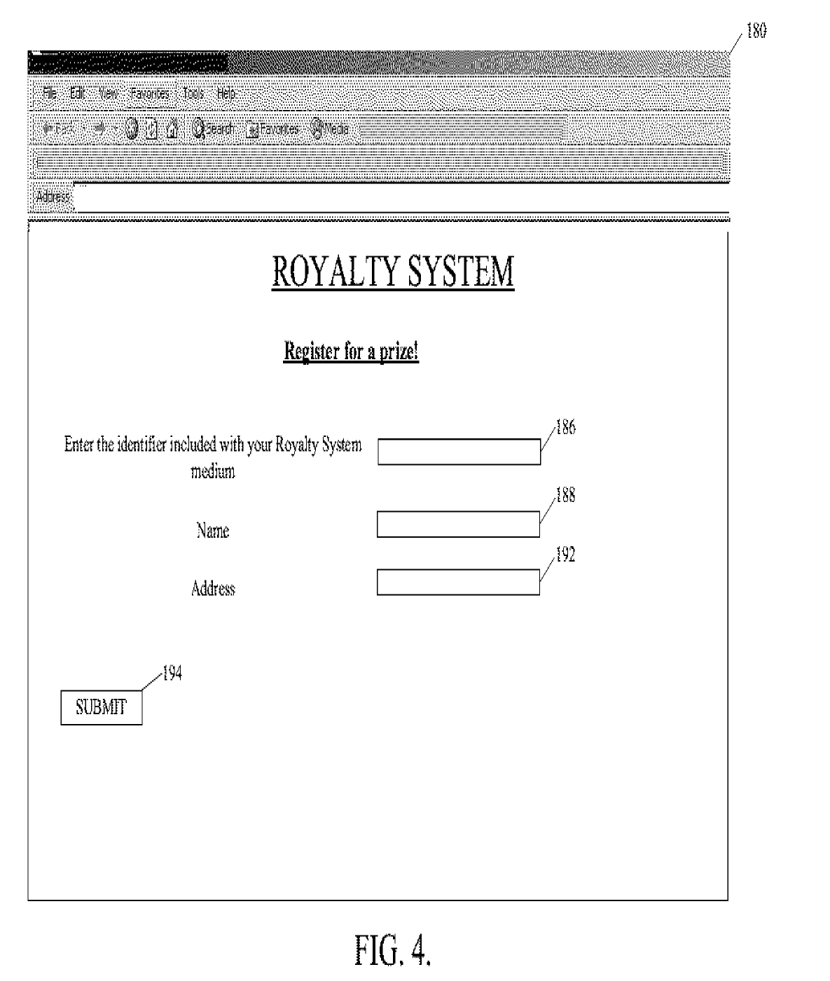

The window 140 includes an active area 148 that allows a user to identify which artist(s)/author(s) that they believe are most likely to be copied. The active area 148 includes a first data entry field 150 that allows a user to enter the name of an artist(s) or author(s) that he/she believes is having or are most likely to have their works copied. In one embodiment, the first data entry field 150 is a pull-down menu that allows selection of various artists/authors, which may be those artists/authors that are subscribers to the service provided by the controlling authority 28. In another embodiment, the active area 148 includes a charity selection data entry field 156 or a pull-down menu that allows a user to enter or select charitable organization that he/she desires to give a portion of the revenue received from the sale of blank mediums. The active area 148 also includes a submit button 158 and a prize button 160. Selection of the submit button 158 instructs the server 32 to record the entries in the fields 150 and 156 into the database 34 for later use. The entries recorded in the first data entry field 150 are used later for distributing a portion of the revenue of the sales of the blank mediums. Selection of the prize button 160 presents a page that allows a purchaser 26 to register for a prize or award, as shown in FIG. 4. Although FIG. 3 is represented in terms of artists “most likely” to be copied, in alternate embodiments users register those works they actually copied or intend to copy.

The server 32 may provide a selection list of authors or artists that have signed up for the service. The user of the associated web pages may select an author(s) or artist(s) that they have or will copy. The server 32 may provide the user the opportunity to select authors or artists that are not signed on to the service.

Referring to FIG. 4, a prize page 180 is displayed or presented after selection of the prize button 160 (FIG. 3). The prize page 180 includes an identifier entry field 186. The purchaser 26 enters a prize entry code into the identifier entry field 186. The prize entry code is an alphanumeric code that is stored electronically on, included with the purchased blank medium, or printed on the blank medium or on a label associated with the blank medium. Name and address entry fields 188 and 192 receive information related to the purchasers 26, for example, name, address, phone number, or any other information that distinguishes the purchaser 26. The information included in the fields 188 and 192 are used for distribution of prizes or awards, such as a portion of the sale of the blank mediums. The prize page 180 includes a submit button 194 that when activated records the information entered in the fields 186-192 into the database 34 for later use in prize determination.

FIG. 5 illustrates an exemplary way to package the blank medium. In this example, the blank medium is a CD 200. The CD 200 is included in a package 202. A unique identifier 206 is included in the package 202 and is viewable upon opening of the package 202. The identifier is a sticker 208 attached to the package 202 or the CD 200, is stored in electronic form on the CD 200, or is printed on the CD 200. In one embodiment, the identifier is the prize entry code.

In another embodiment, the identifier is used as a password to gain access to a network-based file transfer site supported by the controlling authority 28, to a kiosk device also supported by the controlling authority 28, or to some third party associated with the controlling authority 28. The purchaser 26 gains access to the file transfer site, e.g., the kiosk device, by manually entering the identifier included with the purchased blank medium.

In another embodiment, the purchaser 26 inserts the blank medium into a read/write device included in their computer system or included in the kiosk device. Software associated with the file transfer site or the kiosk device reads the identifier off the blank medium (or it is manually entered by the user into an appropriate field) to allow access to file transfer functions. Once the purchaser 26 has gained access to the file transfer site or the kiosk device, the purchaser 26 is allowed to download works stored in the database 34 or in memory of the kiosk device. The works are downloaded and stored on the blank medium. The artists/authors 40 or royalty organizations 42 associated with works stored on the database 34 or the kiosk device have registered or subscribed to the service. The blank medium may be of a certain cash value allowing the user to a certain number of downloads or copies to be made. The server 32, kiosk, home computer, or other device identifies and presents available credit that is associated with the blank medium and the associated identifier. If the user desires more copies or downloads, a new identifier is purchased with a new blank medium or is received from the server 32 over a network connection.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method comprising:
authorizing a purchaser of a recording medium to make copies of certain works onto the purchased recording medium; and
distributing a portion of the sale of the recording medium to registered entities associated with the certain works.

2. The method of claim 1, wherein the recording medium includes computer disks, computer drives, digital video disks, computer floppy disks, memory cards, audio tapes, film, or paper.

3. The method of claim 1, wherein the recording medium is selected from a list consisting of: computer disks, digital video disks, or paper.

4. The method of claim 1, wherein the recording medium includes a written authorization.

5. The method of claim 1, wherein the recording medium includes a unique identifier.

6. The method of claim 5, wherein the identifier is stored electronically on the recording medium.

7. The method of claim 6, further comprising:
determining at a processor if the identifier is valid, wherein authorizing a purchaser further includes authorizing a purchaser if the identifier is determined valid.

8. The method of claim 7, wherein authorizing purchasers further includes:
allowing purchasers to retrieve works from a database and store the retrieved works onto the recording medium using a writing device in communication with the database.

9. The method of claim 1, further comprising:
receiving an identifier associated with a purchased recording medium;
receiving purchaser information; and
registering the purchaser associated with the received purchaser information for an award if the received identifier is a valid identifier.

10. The method of claim 1, wherein the registered entities include at least one of an artist, an author, or a royalty organization.

11. The method of claim 1, wherein the registered entities are selected from a list consisting of: an artist, an author, and a royalty organization.

12. The method of claim 1, further comprising:
distributing a portion of the sale of the recording medium to one or more charitable organizations selected by one of users or artists/authors.

13. A system comprising:
a means for authorizing a purchaser of a recording medium to make copies of certain works onto the purchased recording medium; and
a means for distributing a portion of the sale of the recording medium to registered entities associated with the certain works.

14. The system of claim 13, wherein the recording medium includes computer disks, computer drives, digital video disks, computer floppy disks, memory cards, audio tapes, film, or paper.

15. The system of claim 13, wherein the recording medium is selected from a list consisting of: computer disks, digital video disks, or paper.

16. The system of claim 13, wherein the recording medium includes a written authorization.

17. The system of claim 13, wherein the recording medium includes a unique identifier.

18. The system of claim 17, wherein the identifier is stored electronically on the recording medium.

19. The system of claim 18, further comprising:
a means for determining if the identifier is valid, wherein the means for authorizing purchaser authorizes purchaser if the identifier is determined valid.

20. The system of claim 19, wherein the means for authorizing purchasers further includes:
a means for allowing purchasers to retrieve works from a database; and
a means for storing the retrieved works onto the recording medium using a writing device in communication with the database.

21. The system of claim 13, further comprising:
a means for receiving a identifier associated with a purchased recording medium;
a means for receiving purchaser information; and
a means for registering the purchaser associated with the received purchaser information for an award if the received identifier is a valid identifier.

22. The system of claim 13, wherein the registered entities include at least one of an artist, an author, or a royalty organization.

23. The system of claim 13, wherein the registered entities are selected from a list consisting of:
an artist, an author, and a royalty organization.

24. A system comprising:
an authorizing authority configured to authorize a purchaser of a recording medium to make copies of certain works onto the purchased recording medium and distribute a portion of the sale of the recording medium to registered entities associated with the certain works.

25. The system of claim 24, wherein the recording medium includes computer disks, computer drives, digital video disks, computer floppy disks, memory cards, audio tapes, film, or paper.

26. The system of claim 24, wherein the recording medium is selected from a list consisting of:
computer disks, digital video disks, or paper.

27. The system of claim 24, wherein the recording medium includes a written authorization.

28. The system of claim 24, wherein the recording medium includes a unique identifier.

29. The system of claim 28, wherein the identifier is stored electronically on the recording medium.

30. The system of claim 29, wherein the authorizing authority comprises:
a data entry device configured to receive the identifier;
a memory configured to store approved identifier information; and
a processor in communication with the data entry device and the memory, the processor comprising:
a first component configured to determine if the identifier is one of the approved identifier based on the approved identifier information; and
a second component configured to instruct the purchaser having an approved identifier that they are authorized to make copies of works onto the blank medium.

31. The system of claim 30, wherein the authorizing authority further comprises a database for storing works of the registered entities, wherein the processor further comprises a third component configured to allow purchasers having an approved identifiers to copy works stored on the database to their blank medium.

32. The system of claim 31, wherein the third component includes a network accessible, web page configured to provide access to the database.

33. The system of claim 24, further comprising:
a processor in communication with a network, the processor comprising:
a first component configured to receive a unique identifier associated with a purchased recording medium from a purchaser using a computer device coupled to the network;
a second component configured to receive purchaser information;
a third component configured to determine if the identifier is valid; and
a fourth component configured to register the purchaser associated with the received purchaser information for an award if the received identifier is determined valid.

34. The system of claim 24, wherein the registered entities include at least one of an artist, an author, or a royalty organization.

35. The system of claim 24, wherein the registered entities are selected from a list consisting of:
an artist, an author, and a royalty organization.

36. A method comprising:
distributing to one or more users, in exchange for compensation, a recording medium upon which the one or more users are authorized to make copies of works capable of being copied onto the recording medium;
maintaining a database of registered entities associated with certain works; and
distributing a portion of the compensation for the recording medium to the registered entities associated with the certain works.

37. A system comprising:
a means for distributing to one or more users, in exchange for compensation, a recording medium upon which the one or more users are authorized to make copies of works capable of being copied onto the recording medium;
a means for maintaining a database of registered entities associated with certain works; and
a means for distributing a portion of the compensation for the recording medium to the registered entities associated with the certain works.
